(19) United States
(12) Patent Application Publication
(10) Pub. No.: US 2023/0206197 A1
(43) Pub. Date: Jun. 29, 2023

(54) CARD TO BANK PAYMENTS SOLUTION

(71) Applicant: American Express Travel Related Services Company, Inc., New York, NY (US)

(72) Inventors: Krzysztof LEONARSKI, New York, NY (US); Brett E. MASSENGALE, Phoenix, AZ (US); Kavitha NALLUBOLU, Phoenix, AZ (US); Rahat SHAIKH, Phoenix, AZ (US)

(21) Appl. No.: 17/675,128

(22) Filed: Feb. 18, 2022

Related U.S. Application Data
(60) Provisional application No. 63/294,435, filed on Dec. 29, 2021.

(51) Int. Cl. G06Q 20/10; G06Q 20/24; G06Q 20/20

(52) U.S. Cl. CPC G06Q 20/102; G06Q 20/24; G06Q 20/20

(57) ABSTRACT

Disclosed herein are system, method, and computer program product embodiments for a method of automated payment processing. In some embodiments, the method may receive a transaction request from a purchaser to transfer a payment amount from a purchaser account of the purchaser to a supplier account associated with a supplier. The transaction request may be an invoice including a payment amount for the specific transaction and a supplier identification number identifying the supplier. In response to the transaction request, the method debits the payment amount from the purchaser account, identifies the supplier account based on the supplier identification number, and credits the payment amount to the identified supplier account. The purchaser account may be linked to a transaction card used to pay the payment amount. The method allows automated payment processing without transmission of a transaction account number linked to the purchaser account.

### BACKGROUND

### Field

This field is generally related to a method of automated payment processing.

### Related Art

To complete a transaction, a credit card may be physically presented at a point of sale to be swiped. When a physical credit card is not present at the point of sale (i.e., “card not present” transactions), such as through an online commercial transaction, credit card numbers may be transmitted via email or phone from a purchaser to a supplier to be manually entered at the point of sale.

Security issues may arise with using physical credit cards and transmitting credit card numbers to complete transactions at the point of sale. Physical credit cards may be stolen or lost. Credit card numbers transmitted from the purchaser to the supplier during “card not present” transactions may be leaked during a security breach. Because the same credit card number may be used to complete multiple transactions, unauthorized personnel may use the leaked credit card number to make fraudulent purchases. Furthermore, the process of transmitting credit card numbers to be manually entered at the point of sale is time consuming and inconvenient. A supplier may receive multiple emails including sensitive credit card information for various transactions, thus introducing confusion, delay, and opportunities for human error.

### BRIEF SUMMARY

Disclosed herein are system, apparatus, device, method and/or computer program product embodiments, and/or combinations and sub-combinations thereof, for a method of automated payment processing.

A method of automated payment processing may push payment directly from a purchaser account of a purchaser to a supplier account of a supplier without transmitting a transaction account number linked to the purchaser account. The method may first receive a transaction request from a purchaser to transfer a payment amount from the purchaser account of the purchaser to the supplier account associated with a supplier. In some embodiments, the transaction request may allow the purchaser to select, from an interface, the supplier or supplier account in which to credit the payment amount. In other embodiments, the transaction request may be an invoice transmitted from the supplier to the purchaser specifying the payment amount and a supplier identification number identifying the supplier. In this example, after receiving the invoice, the purchaser may input a transaction request to pay the requested amount. Upon receiving the transaction request from the purchaser to transfer the payment amount from the purchaser account to the supplier account, the method debits the payment amount from the purchaser account, identifies the supplier account based on the supplier identification number, and credits the payment amount to the identified supplier account. The purchaser account is linked to a transaction card, which is used to pay the requested amount in the transaction. The supplier account may be a merchant account that allows the supplier to accept payments from transaction cards linked to the purchaser account. The method may periodically reconcile the supplier account to deposit its balance into another bank account of the supplier, such as an external checking account. This reconciliation process may automatically settle the processed transaction request after a predetermined period of time. For example, to simplify the reconciliation process, the method may automatically reconcile the supplier account at the end of each business day.

The method is further configured to notify the supplier and the purchaser after completing the requested transaction. The supplier is notified after crediting the supplier account with the payment amount, and the purchaser is notified after debiting the purchaser account with the payment amount.

While a single transaction request is described in the above description, the method may execute a plurality of transaction requests received simultaneously. One notification may be generated and used to reconcile the plurality of transaction requests between one purchaser and one supplier, thus simplifying the payment process, increasing efficiency, and decreasing the opportunity for delay and error.

In this method, the process of pushing payment directly from the purchaser account to the supplier account occurs substantially simultaneously with receiving the transaction request from the purchaser. For example, the automated payment processing may push the payment amount from the purchaser account to the supplier account within seconds of receiving the transaction request. This provides an efficient and effortless way for suppliers to quickly receive a plurality of payments from various purchasers. The method also eliminates potential lag time between the purchaser transmitting credit card information to the supplier and the supplier manually entering the credit card information at the point of sale.

In some embodiments, the method is further configured to determine whether the supplier account is enrolled in the automated payment processing. If the method determines that the supplier account is enrolled in the automated payment processing, then the method proceeds to debit the payment amount from the purchaser account, identify the supplier account based on the supplier identification number, and credit the payment amount to the identified supplier account. On the other hand, if the method determines that the supplier account is not enrolled in the automated payment processing, then the method proceeds to generate a virtual account number that is unique for the specific transaction request from the purchaser. The virtual account number is then transmitted to the supplier to manually enter at the point of sale.

In some embodiments, virtual account numbers are generated to enhance security during transmission of sensitive credit card information in “card not present” transactions. A virtual account number, also referred to as a token, is a one-time number generated for a specific payment transaction and transmitted to the supplier to manually enter at the point of sale. During “card not present” transactions, one credit card number may be transmitted to complete multiple transaction requests. On the other hand, when virtual account numbers are used to complete transactions, a different virtual account number is generated and transmitted for each transaction request from the same credit card number.

In some embodiments, the method is further configured to determine, based on a stored supplier preference, whether the supplier wishes to complete a transaction request using the automated payment processing or the virtual account number. Optionally, when enrolling in the automated payment processing, suppliers may specify whether they wish to process transactions using the automated payment processing, the virtual account number, or a combination of both. The supplier preference may indicate a different method to be used to process transactions based on the identity of the purchaser or the transaction type. For example, suppliers may specify in the supplier preference to process transactions using the automated payment processing for some purchasers while using the virtual account number for other purchasers. Suppliers may also specify processing certain transaction types using the automated payment processing while processing other transaction types using the virtual account number. Suppliers may be offered the opportunity to specify a supplier preference when enrolling in the automated payment processing via a website, a mobile application, or the like.

### BRIEF DESCRIPTION OF THE DRAWINGS

The accompanying drawings are incorporated herein and form a part of the specification.

FIG. 1 depicts a flowchart illustrating a method for automated payment processing, according to some embodiments.

FIG. 2 depicts a flowchart illustrating a method for determining whether to execute the automated payment processing shown in FIG. 1 or to execute a token method by generating a virtual account number, according to some embodiments.

FIG. 3 depicts a flowchart illustrating a method for executing a plurality of transaction requests to be reconciled through one notification, according to some embodiments.

FIG. 4 depicts an example email notification sent to a supplier after completing a periodic reconciliation process, according to some embodiments.

FIG. 5 depicts a block diagram of an example computer system for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a method of automating a virtual payment process. Various embodiments of these features will now be discussed with respect to the corresponding figures.

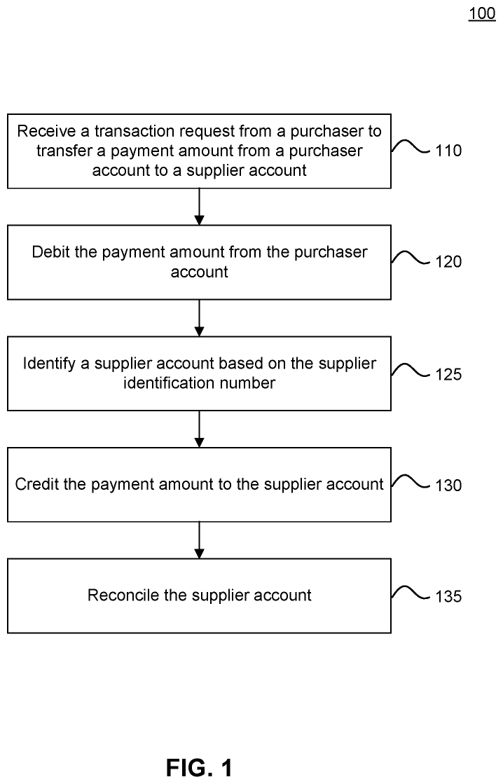

FIG. 1 depicts a flowchart of a method 100 for automated payment processing, according to some embodiments. In step 110, a purchaser may provide a transaction request to initiate the automated payment processing and directly push a payment amount from a purchaser account of the purchaser to a supplier account associated with a supplier. In some embodiments, the transaction request may allow the purchaser to select, from an interface, the supplier or supplier account in which to credit the payment amount. In other embodiments, the transaction request may be an invoice transmitted from the supplier to the purchaser. The invoice may include, among other things, an invoice number identifying the invoice, a payment amount for the specific transaction, and a supplier identification number identifying the supplier. In this embodiment, the purchaser may be able to initiate the transaction request by pushing a button labeled “pay amount” on an electronic invoice.

In response to receiving the transaction request, method 100 executes steps 120-130. In step 120, method 100 debits the payment amount from the purchaser account. In some embodiments, the purchaser account is linked to a transaction card, which may be a credit card used to pay the requested amount and complete the transaction. In these embodiments, the debiting of the purchaser account is equivalent to the purchaser using a credit card to pay the transaction amount without ever presenting the credit card (as required during a physical card transaction) or providing the supplier with sensitive credit card information (as required during a “card not present” transaction). Such a “cardless” transaction allows for a quick and simple transaction for the purchaser similar to a direct wire transfer of money while still providing the purchaser with credit card purchase protection. For example, in some embodiments, the transaction request may be protected by available protection procedures implemented by the merchant acquiring bank that issued the transaction card linked to the purchaser account and used to pay the payment amount.

In step 125, method 100 identifies the supplier account to receive the payment amount based on the supplier identification number. A supplier account may be a merchant account that is used to process and accept payments, for example using a point of sale. A merchant account is a type of account that allows businesses to accept payments in multiple ways, typically debit or credit cards. A merchant account is established under an agreement between an acceptor and a merchant acquiring bank for the settlement of payment card transactions. In some embodiments, the merchant acquiring bank is the same entity that issued the transaction card linked to the purchaser account and used to pay the payment amount. In some cases, such as when a virtual card number is used to pay the payment amount and complete the transaction, a payment processor, independent sales organization (ISO), or member service provider (MSP) is also a party to the merchant agreement. The merchant agreement includes operating regulations established by the card associations.

After acquiring a transaction card with the merchant acquiring bank, each supplier is assigned a unique supplier identification number. In some embodiments, this supplier identification number may be used to identify the supplier when executing method 100. Each supplier may be assigned a supplier identification number regardless of whether the supplier enrolls in the automated payment processing. In some embodiments, the supplier identification number may be a number that is randomly generated for each supplier. As such, the supplier identification number only identifies a supplier within a system, such as the system described in the present disclosure, and does not contain sensitive information for the supplier. For example, the supplier identification number is not generated based on an account number of the supplier account.

In step 130, method 100 credits the identified supplier account associated with the supplier and the supplier identification number with the payment amount that was debited from the purchaser account in step 120. This process of debiting the purchaser account, identifying the supplier account, and crediting the identified supplier account occurs without the transmission of sensitive information for either the purchaser or the supplier. For example, execution of steps 120-130 do not include transmitting a transaction account number associated with the purchaser account, transmitting a transaction account number associated with the supplier account, or transmitting sensitive card information of the transaction card linked to the purchaser account. Steps 120-130 occur in backend systems such that the purchaser and the supplier are not aware of the execution of steps 120-130 when completing a transaction. Furthermore, the process of pushing the payment amount directly from the purchaser account to the supplier account occurs substantially simultaneously with receiving the transaction request from the purchaser. For example, in some embodiments, method 100 may push the payment amount from the purchaser account to the supplier account in steps 120-130 within a few seconds of receiving the transaction request in step 110. This provides an efficient and effortless way for suppliers to quickly receive payments from purchasers.

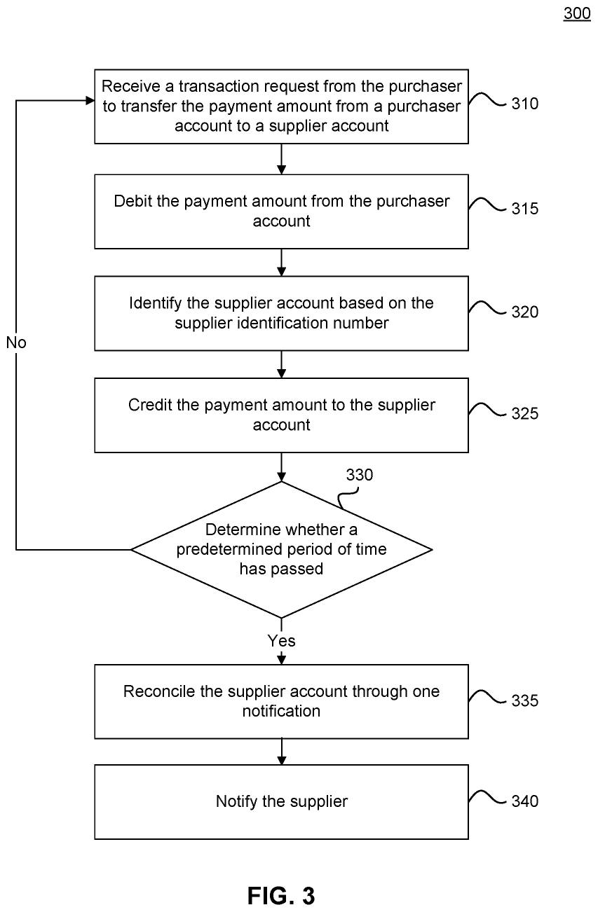

After the payment amount is transferred from the purchaser account to the supplier account, method 100 executes step 135 to reconcile the supplier account. In some embodiments, the supplier account is a merchant account that allows the supplier to accept payments from transaction cards linked to the purchaser account. In step 135, the supplier account is reconciled by depositing a balance of the supplier account into another bank account of the supplier, such as an external checking account. In some embodiments, this reconciliation process may occur periodically, such as at the end of each business day. A periodic reconciliation process is described in further detail below with reference to FIG. 3.

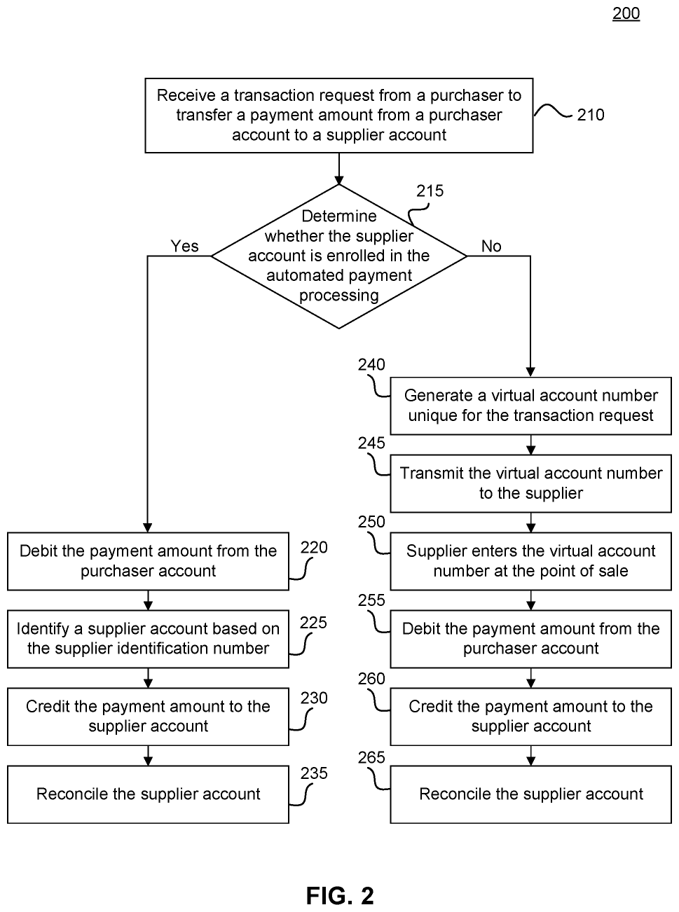

FIG. 2 depicts a flowchart illustrating a method 200 for determining whether to execute method 100 for automated payment processing shown in FIG. 1, or to execute a token method by generating a virtual account number, according to some embodiments. In some embodiments, method 200 begins similarly to method 100. In step 210, a purchaser provides a transaction request to transfer a payment amount from a purchaser account to a supplier account. In some embodiments, the transaction request may be an invoice transmitted from the supplier to the purchaser. The invoice may include, among other things, the payment amount of the specific transaction and a supplier identification number identifying the supplier. A transaction card, such as a credit card, is linked to the purchaser account and used to pay the payment amount in the requested transaction. Next, method 200 executes decision 215 to determine whether to proceed with steps 220-230 similar to steps 120-130 of method 100, or to proceed with steps 240-260 of a token method.

In decision 215, method 200 determines whether the supplier account is enrolled in the automated payment processing. In some embodiments, method 200 may make this determination by searching for the supplier identification number associated with the supplier account of the supplier. Since the supplier identification number is generated and assigned to each supplier account when the supplier acquires a transaction card used to execute the automated payment processing and pay the payment amount, an existing supplier identification number for the supplier may be an indication that the associated supplier account is enrolled in the automated payment processing. In other embodiments, method 200 may make the determination in decision 215 by searching for the supplier's name or other personal information of the supplier. In other embodiments, method 200 may make the determination in decision 215 by searching directly for the supplier account associated with the supplier.

If method 200 determines in decision 215 that the supplier account is enrolled in the automated payment processing, method 200 proceeds to execute the automated payment processing of debiting the payment amount from the purchaser account (step 220), identifying the supplier account based on the supplier identification number (step 225), and crediting the payment amount to the identified supplier account (step 230). In step 235, method 200 reconciles the supplier account for the completed transaction, similar to step 135 described above with reference to FIG. 1. Steps 220-230 comprise the automated payment processing method described with reference to steps 120-130 of FIG. 1.

On the other hand, if method 200 determines in decision 215 that the supplier account is not enrolled in the automated payment processing, method 200 proceeds to execute a token method of steps 240-260. In step 240, a virtual account number, also referred to as a token, is randomly generated for the received transaction request. Each virtual account number is randomly generated and does not contain any sensitive credit card information, such as the original credit card number on the transaction card used to pay the payment amount. Using a virtual account number reduces the exposure to a credit limit associated with that card. Also, a virtual account number may have other restrictions, such as a restriction that limits its use to a particular business. This bolsters security over using encryption methods alone, which still transmit the original sensitive credit card information on the transaction card but relies on an encoding process before transmission and a decoding process upon receipt at the point of sale to secure the transmission process. Encryption methods may be reversed to recover sensitive card information intercepted during transmission, whereas virtual account numbers randomly generated for each transaction does not contain any sensitive card information at all. By generating and transmitting the unique virtual account number for each transaction, sensitive credit card information no longer needs to be transmitted, thus decreasing the possibility of the credit card number being leaked and fraudulently reused. In some embodiments, an encryption method may be used in addition to a virtual card number to secure transactions where the payment amount is in excess of $25,000. Furthermore, multiple people sharing a single company credit card may avoid the error and confusion of sharing one physical credit card, which in turn saves time and reduces the need for manual reconciliation to ensure accounting accuracy after completing transactions. However, virtual account numbers must still be transmitted and manually entered at the point of sale by the supplier. This process is time consuming, inconvenient, and prone to human error, thus making the token method a less desirable option than the automated payment processing method.

In some embodiments, the virtual account number may be a fifteen digit number that is unique for identifying the received transaction request. The virtual account number is randomly generated and not based on encrypting sensitive credit card information for the transaction card linked to the purchaser account that is used to pay the payment amount in the received transaction request. As such, when the virtual account number is transmitted to the supplier in step 245, no original sensitive credit card information on the transaction card is transmitted. This increases security in processing the transaction request by protecting the transaction card used to pay the payment amount even when the virtual account number is leaked or intercepted during transmission.

After receiving the virtual account number transmitted in step 245, the supplier may manually enter the virtual account number for the transaction request at the point of sale (step 250). Once entered, method 200 proceeds to steps 255-260 of debiting the payment amount from the purchaser account (step 255) and crediting the payment amount to the supplier account (step 260). Steps 255-260 are similar to the usual business methods available for transferring money between two accounts and thus not described herein in specific detail. After transferring the payment amount from the purchaser account to the supplier account, method 200 reconciles the supplier account (step 265), similar to step 135 and step 235 explained above.

In some embodiments, decision 215 may also include determining a supplier preference of the supplier. The supplier preference may include guidelines provided by the supplier when enrolling in the automated payment processing of method 100. In some embodiments, optionally, the supplier preference may include instructions to process transaction requests using the automated payment processing (steps 220-230) for certain purchasers or transaction types while using the token method (steps 240-260) for other purchasers or transaction types. For example, the supplier preference may specify to use the automated payment processing for a first list of purchasers and the token method for a second list of purchasers. In this example, a transaction request provided by a purchaser on the second list would be processed using the token method (steps 240-260) even though the supplier is determined to be enrolled in the automated payment processing in decision 215. Suppliers may further specify different supplier preferences for different purchasers based on their relationship with the purchaser or based on the types of transactions with the purchaser. For example, a supplier may specify in the supplier preferences to always complete transaction requests using the automated payment processing method for a first purchaser who has a long-standing business relationship with the supplier, and to always complete transaction requests using the token method for a second purchaser who only occasionally conducts business with the supplier. Similarly, the supplier may specify in the supplier preferences to complete a first type of transaction requests from a purchaser using the automated payment processing method and to complete a second type of transaction requests from the same purchaser using the token method. The ability to mix-and-match which method is used to complete each transaction request based on specified categories gives the supplier great flexibility and control over the transaction process.

In addition, the transaction card linked to the purchaser account may be a closed-loop card in some embodiments. The closed-loop transaction card limits the transaction request to be between a purchaser and a supplier who are both on a predefined list of accepted parties. This closed-loop system simplifies the process for suppliers when enrolling in the automated payment processing. Smaller suppliers who may not have the resources to negotiate independent contracts with each purchaser to execute direct pushing of payment from the purchaser account to the supplier account may more easily and efficiently enroll in the automated payment processing described in the present disclosure. Therefore, suppliers enrolled in the automated payment processing may achieve higher efficiency and higher buyer-to-buyer acceptance of transaction requests.

FIG. 3 depicts a flowchart illustrating a method 300 for executing a plurality of transaction requests to be reconciled through one notification, according to some embodiments. Method 300 begins similarly to method 100. In step 310, method 300 receives a transaction request initiated by a purchaser to transfer a payment amount from a purchaser account to a supplier account. In some embodiments, the transaction request may be an invoice including a payment amount for the specific transaction and a supplier identification number identifying the supplier. The payment amount is then debited from the purchaser account (step 315), the supplier account is identified based on the supplier identification number (step 320), and the payment amount is credited to the identified supplier account (step 325). Method 300 then proceeds to decision 330 to determine whether a predetermined period of time has passed.

If the predetermined period of time has not yet passed, method 300 repeats steps 310-325 to process another transaction request for another payment amount between the purchaser and the supplier. Therefore, multiple transaction requests may be completed between one purchaser and one supplier within the predetermined time period. If the predetermined period of time has passed, method 300 proceeds to step 335 to reconcile the supplier account. In step 335, method 300 reconciles all transaction requests completed during the predetermined time period by depositing the entire balance of the supplier account into another bank account of the supplier. In this embodiment, the entire balance of the supplier account includes all payment amounts received for each transaction request during the predetermined time period. Since the entire balance of the supplier account is deposited into the another bank account of the supplier all at once, only one notification is needed to reconcile the plurality of transaction requests completed during the predetermined time period. This streamlines and simplifies the reconciliation process for the supplier, especially when transacting with a purchaser that frequently initiates multiple transaction requests with the supplier during the course of business.

In some embodiments, the predetermined period of time may be one day. In other embodiments, various predetermined periods of time may be selected, such as two days or three days.

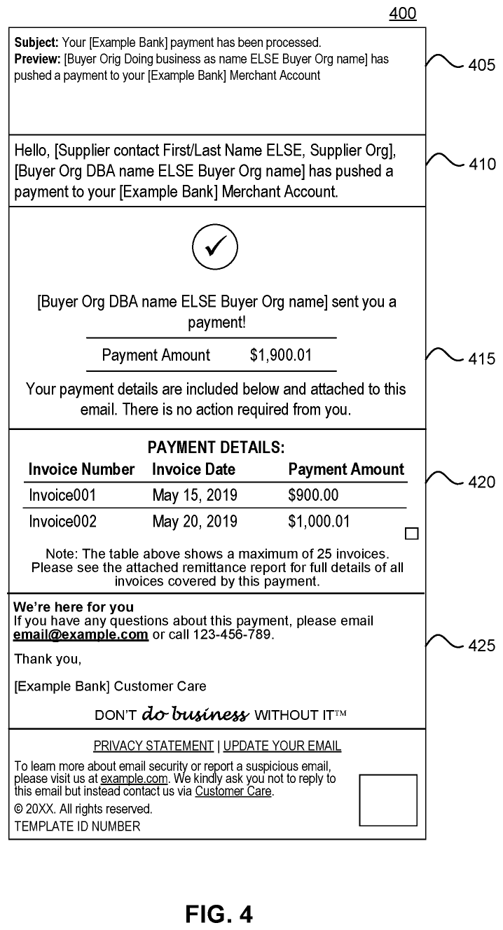

Method 300 then proceeds to execute step 340 and notify the supplier of the one notification including the plurality of transaction requests completed during the predetermined time period. After completing the reconciliation process in step 335, method 300 sends the one notification to the supplier, wherein the one notification includes the bank invoice used to reconcile the plurality of transaction requests completed during the predetermined time period. The notification provided may be any electronic notification, such as an email, a text message, a push-notification on a mobile application, etc. An exemplary email notification sent to the supplier after completing a periodic reconciliation process is shown in FIG. 4.

FIG. 4 depicts an example email notification 400 sent to a supplier after completing a periodic reconciliation process, according to some embodiments. The periodic reconciliation process may be similar to method 300 described above with reference to FIG. 3. As shown in FIG. 4, the example email notification 400 sent to a supplier includes the bank invoice used to reconcile the plurality of transaction requests during the predetermined time period. The email notification 400 may include a heading section 405, a salutation section 410, a payment overview section 415, a payment details section 420, and a contact information section 425.

In the heading section 405, the email notification 400 includes a brief subject and preview. The heading section 405 lets the supplier know that the payment amount of at least one transaction request initiated by a purchaser has been pushed from the purchaser account to the supplier account. In the salutation section 410, the supplier name and the purchaser name are identified. In the payment overview section 415, the entire balance of the supplier account that is being reconciled by the bank invoice in the email notification 400 is shown. This entire balance includes the payment amounts of each transaction request completed during the predetermined time period before beginning the reconciliation process.

Details of the balance up to 25 invoices may be listed in the payment details section 420, including a number for each transaction request (“Invoice Number”), a date that each transaction request is processed (“Invoice Date”), and the payment amount for each transaction request (“Payment Amount”). For example, in the embodiment provided in FIG. 4, the email notification 400 shows the bank invoice for two transaction requests: $900.00 pushed from the purchaser account to the supplier account on May 15, 2019, and $1,000.01 pushed from the purchaser account to the supplier account on May 20, 2019. Contact information for the merchant acquiring bank completing the plurality of transaction requests is provided in the contact information section 425 for easy access to the merchant acquiring bank.

By providing one email notification 400 including one bank invoice for a plurality of transaction requests completed during the predetermined time period, suppliers are able to reconcile their supplier accounts much more efficiently and accurately than receiving a notification after processing each individual transaction request from a purchaser.

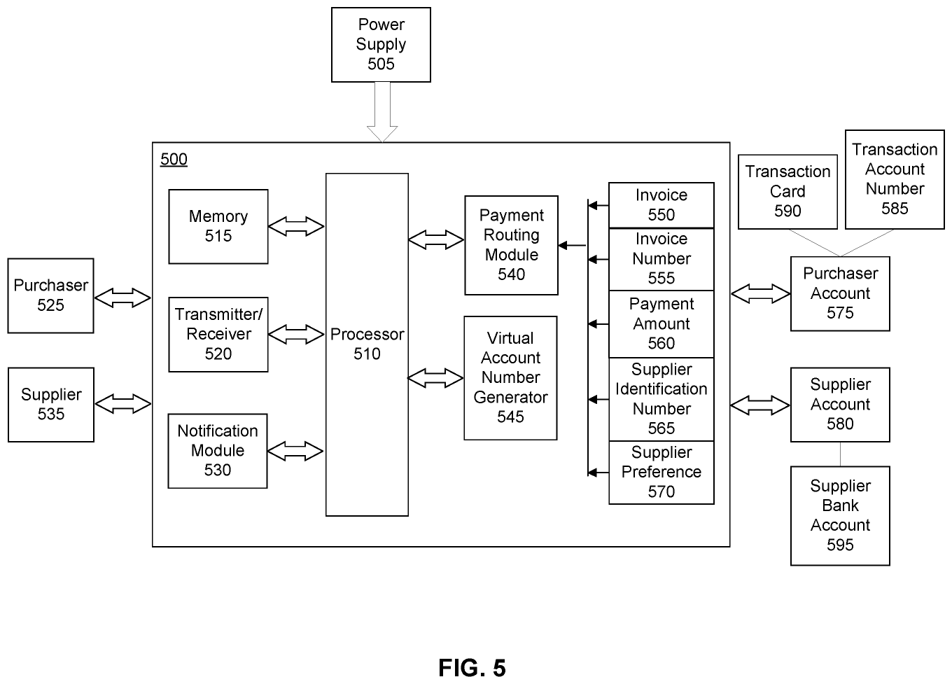

FIG. 5 depicts a block diagram of an example computer system 500 for implementing various embodiments of the methods described above. One or more computer systems 500 may be used, for example, to implement any of the embodiments discussed herein, as well as combinations and sub-combinations thereof. The computer system 500 shall be described with reference to FIGS. 1-4; however, the computer system 500 is not limited to the example embodiments described in the previous figures.

In some embodiments, the computer system 500 may receive power from an external power supply 505. The computer system may include one or more processors (also called central processing units, or CPUs), such as a processor 510. The computer system 500 may also include a memory 515, such as random access memory (RAM). Memory 515 may include one or more levels of cache. Memory 515 may have stored therein control logic (i.e., computer software) and/or data. The processor 510 may execute program code with instructions stored in the memory 515 to perform operations implementing various embodiments described herein.

The computer system 500 may include a transmitter/receiver 520 for transmitting and receiving communications between a purchaser 525 and a supplier 535. For example, with reference to method 100 in FIG. 1, the transmitter 520 may, according to some embodiments, transmit an invoice including a payment amount and a supplier identification number from the supplier 535 to the purchaser 525. The transmitter/receiver 520 may likewise receive the transaction request from the purchaser 525 in step 110. The computer system 500 may also include a notification module 530 for providing notifications to the purchaser 525 and supplier 535. For example, with reference to method 300 and FIGS. 3 and 4, the notification module 530 may provide the email notification 400 to the supplier 535 in step 340 so that the supplier 535 may reconcile the plurality of transaction requests completed during the predetermined time period in decision 330.

The computer system 500 further includes a payment routing module 540 and a virtual account number generator 545. In some embodiments, the payment routing module 540 is configured to implement various embodiments of the automated payment processing, described with reference to methods 100-300 in FIGS. 1-3. The payment routing module 540 may store various information needed to implement the automated payment processing, including but not limited to, an invoice 550, an invoice number 555 assigned to each invoice 550, a payment amount 560 for each transaction request, a supplier identification number 565 associated with each supplier 535, and a supplier preference 570. In some embodiments, the invoice 550 and the invoice number 555 may be optional, and other methods of receiving the payment amount 560 and supplier identification number 565 may be used (e.g., the purchaser 525 may select the payment amount 560 or the supplier identification number 565 from a dropdown menu in an online portal without having to receive the invoice 550 or the invoice number 555). The computer system 500 is in communication with a purchaser account 575 and a supplier account 580 such that the payment amount 560 of an invoice 550 may be pushed directly from the purchaser account 575 to the supplier account 580. The purchaser account 575 may be linked to a transaction account number 585 identifying the purchaser account 575 and a transaction card 590, such as a credit card used to pay the payment amount 560. The supplier account 580 may be linked to a supplier bank account 595, which may be a second bank account of the supplier, such as a checking account. In some embodiments, the balance of the supplier account 580 may be deposited into the external supplier bank account 595 to reconcile the supplier account 580.

The processor 510 of the computer system 500 may determine whether to execute the automated payment processing method or the token method based on various considerations, including, but not limited to, instructions stored in the supplier preference 570 or the existence of a supplier identification number 565 or a supplier account 580 associated with the supplier 535. For example, with reference to method 200 of FIG. 2, the processor 510 of the computer system 500 may make the determination in decision 215 whether to execute the automated payment processing method or the token method. If the automated payment processing is executed, the payment routing module 540 executes steps 220-230, including debiting the payment amount 560 from the purchaser account 575 (step 220), identifying the supplier account 580 based on the supplier identification number 565 (step 225), and crediting the payment amount 560 to the identified supplier account 580 (230). If the token method is executed, the virtual account number generator 545 generates a virtual account number in step 240. After the virtual account number is transmitted to the supplier 535 (step 245) and the supplier 535 enters the virtual account number at the point of sale (step 250), the payment routing module 540 may then proceed to push the payment amount 560 from the purchaser account 575 directly to the supplier account 580 (steps 255-260).

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, processor 510, memory 515, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer implemented method for automated payment processing, comprising:
(a) receiving a transaction request from a purchaser system to transfer a payment amount from a purchaser account corresponding to a purchaser to a supplier account associated with a supplier, wherein the transaction request is generated from a purchaser selection of an identifier corresponding to the supplier, the identifier being displayed on a graphical user interface accessed via the purchaser system, and wherein the purchaser account is linked to a transaction card and a transaction account number;
in response to the transaction request:
(b) debiting the payment amount from the purchaser account;
(c) identifying the supplier account based on the identifier;
(d) crediting the payment amount to the supplier account associated with the supplier, the supplier account being a first bank account that allows the supplier to accept payments from transaction cards; and
(e) periodically reconciling the supplier account to deposit a balance of the supplier account into a second bank account of the supplier,
wherein the transaction request enables the automated payment processing without transmission of the transaction account number to the supplier.

2. The method according to claim 1, further comprising:
notifying the supplier of the crediting of the payment amount to the supplier account; and
notifying the purchaser of the debiting of the payment amount from the purchaser account.

3. The method according to claim 1, further comprising:
receiving a second transaction request including a second identification corresponding to a second supplier account;
determining, based on the second identification, that the second supplier account is not enrolled in the automated payment processing;
in response to the determining:
generating a virtual account number unique to the second transaction request; and
transmitting the virtual account number to a second supplier corresponding to the second supplier account.

4. The method according to claim 1, wherein step (e) of periodically reconciling the supplier account comprises:
automatically settling the transaction request after a predetermined period of time.

5. The method according to claim 1, further comprising:
determining that the supplier account is enrolled in the automated payment processing.

6. The method according to claim 1, wherein the transaction card is a credit card with credit card purchase protection.

7. The method according to claim 1, wherein the transaction card is a closed-loop card that limits the transaction request to be between the purchaser and a predefined list of suppliers.

8. The method according to claim 1, wherein the transaction request comprises transmitting, to the purchaser, an invoice from the supplier, the invoice specifying the payment amount and the identifier corresponding to the supplier.

9. The method according to claim 1, further comprising:
displaying an electronic invoice on the graphical user interface with a graphical user interface object;
receiving, via the graphical user interface, an interaction with the graphical user interface object; and
in response to receiving the interaction, generating an interface allowing the purchaser system to submit the transaction request.

10. The method according to claim 1, wherein the automated payment processing is configured to execute a plurality of transaction requests simultaneously.

11. The method according to claim 10, wherein step (e) of periodically reconciling the supplier account comprises:
automatically settling the plurality of transaction requests through one notification.

12. A system for automating payment processing, comprising:
a memory; and
at least one processor coupled to the memory and configured to:
(a) receive a transaction request from a purchaser system to transfer a payment amount from a purchaser account corresponding to a purchaser to a supplier account associated with a supplier, wherein the transaction request is generated from a purchaser selection of an identifier corresponding to the supplier, the identifier being displayed on a graphical user interface accessed via the purchaser system, and wherein the purchaser account is linked to a transaction card and a transaction account number;
in response to the transaction request:
(b) debit the payment amount from the purchaser account;
(c) identify the supplier account based on the identifier;
(d) credit the payment amount to the supplier account associated with the supplier, the supplier account being a first bank account that allows the supplier to accept payments from transaction cards; and
(e) periodically reconcile the supplier account to deposit a balance of the supplier account to a second bank account of the supplier,
wherein the transaction request enables the automated payment processing without transmission of the transaction account number to the supplier.

13. The system according to claim 12, further comprising:
notification circuitry configured to
notify the supplier of the crediting of the payment amount to the supplier account; and
notify the purchaser of the debiting of the payment amount from the purchaser account.

14. The system according to claim 12, wherein the at least one processor is further configured to:
receive a second transaction request including a second identification corresponding to a second supplier account;
determine, based on the second identification, that the second supplier account is not enrolled in the automated payment processing;
in response to the determining:
generate a virtual account number unique to the second transaction request; and
transmit the virtual account number to a second supplier corresponding to the second supplier account.

15. The system according to claim 12, wherein the transaction request comprises transmitting, to the purchaser, an invoice from the supplier, the invoice specifying the payment amount and the identifier corresponding to the supplier.

16. The system according to claim 12, wherein step (e) of periodically reconciling the supplier account comprises:
automatically settling the transaction request after a predetermined period of time.

17. The system according to claim 12, wherein the at least one processor is further configured to:
determining that the supplier account is enrolled in the automated payment processing.

18. A non-transitory computer-readable medium having instructions stored thereon that, when executed by at least one processor, cause the at least one processor to perform operations comprising:
(a) receiving a transaction request from a purchaser system to transfer a payment amount from a purchaser account corresponding to a purchaser to a supplier account associated with a supplier, wherein the transaction request is generated from a purchaser selection of an identifier corresponding to the supplier, the identifier being displayed on a graphical user interface accessed via the purchaser system, and wherein the purchaser account is linked to a transaction card and a transaction account number;
in response to the transaction request:
(b) debiting the payment amount from the purchaser account;
(c) identifying the supplier account based on the identifier;
(d) crediting the payment amount to the supplier account associated with the supplier, the supplier account being a first bank account that allows the supplier to accept payments from transaction cards; and
(e) periodically reconciling the supplier account to deposit a balance of the supplier account to a second bank account of the supplier,
wherein the transaction request enables the automated payment processing without transmission of the transaction account number to the supplier.

19. The non-transitory computer-readable medium according to claim 18, the operations further comprising:
notifying the supplier of the crediting of the payment amount to the supplier account; and
notifying the purchaser of the debiting of the payment amount from the purchaser account.

20. The non-transitory computer-readable medium according to claim 18, the operations further comprising:
receiving a second transaction request including a second identification corresponding to a second supplier account;
determining, based on the second identification, that the second supplier account is not enrolled in the automated payment processing;
in response to the determining:
generating a virtual account number unique to the second transaction request; and
transmitting the virtual account number to a second supplier corresponding to the second supplier account.
